(19) United States
(12) Patent Application Publication
(10) Pub. No.: US 2006/0273545 A1
(43) Pub. Date: Dec. 7, 2006

(54) MOTORCYCLE REAR SUSPENSION SYSTEM

(76) Inventor: Greg M. Parigian, Chatsworth, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/461,523

(22) Filed: Aug. 1, 2006

Related U.S. Application Data
(63) Continuation-in-part of application No. 10/991,191, filed on Nov. 16, 2004, now Pat. No. 7,086,658.
Application No. 10/991,191 is a continuation of application No. 10/414,631, filed on Apr. 15, 2003, now Pat. No. 6,871,867.
Application No. 10/414,631 is a continuation-in-part of application No. 10/050,315, filed on Jan. 15, 2002, now abandoned.
Application No. 10/050,315 is a continuation-in-part of application No. 09/740,517, filed on Dec. 19, 2000, now abandoned.

(51) Int. Cl. B62K 11/00

(52) U.S. Cl. 280/286

(57) ABSTRACT

A motorcycle rear suspension system has a generally triangular configuration that includes upper and lower pivot arm assemblies pivotally connected the motorcycle frame. A rear wheel supporting unit, including upper and lower arm assemblies, is connected to at least one axle of a rear wheel of the motorcycle. The upper arm assembly of the support unit is connected to the upper pivot arm assembly, and the lower arm assembly of the support unit is connected to the lower pivot arm assembly. A control arm, the movement of which is controlled, is interconnected between the pivot arm assemblies.

### BACKGROUND OF THE INVENTION

The present invention relates generally to two-wheeled vehicles. More particularly, the present invention relates to a rear suspension system for two-wheeled motor vehicles, and in particular motorcycles, employing pivoting arm assemblies and control arms possessing shock absorption characteristics and providing lateral stability.

The existing designs of most prior art rear suspension assemblies for two-wheeled motor vehicles include a rear pivot from a single point either from a dual or mono shock system that either extends or comprises the shock unit. In this respect, when the shock system is affected by power or braking to the rear wheel, system efficiency and stability are compromised. Other systems use a quad-type configuration that only connects to a small section of the frame, providing less structural integrity.

Although recent motorcycle frames include a swing arm configuration, these configurations posses certain deficiencies that detract from their overall utility. The swing arm movement is typically in a single pivoting motion with no lateral stability. This causes lateral instability for the rear wheel of the motorcycle. Many existing suspension systems provide inadequate control of the wheel to pavement contact. This can create safety concerns regarding the control of the increased stopping during braking. Aside from the rear wheel wobbling, as described above, many current designs transfer force back to the front of the vehicle under acceleration.

Accordingly, there is a need for a rear suspension system for a two-wheeled motor vehicle, which improves rear wheel geometry. Such a system should also increase lateral stability of the rear wheel of the vehicle and improve wheel contact with the pavement. Such a system should further contain the power under acceleration and not transfer force back to the front of the vehicle. The present invention fulfills these needs and provides other related advantages.

### SUMMARY OF THE INVENTION

The present invention resides in a rear suspension system for two-wheeled motor vehicles. The system of the present invention has the ability to keep the same arc from the wheel axle point and the transmission drive sprocket positions as the suspension moves upwardly and downwardly, thus plotting a constant path in relation between axes points. The system can be adjustable for any desired arc pattern.

The system of the present invention generally comprises upper and lower pivot arm assemblies pivotally connected to the frame of the vehicle. A rear wheel support unit has an upper end thereof pivotally connected to the upper pivot arm assembly. A lower end of the rear wheel support unit is pivotally connected to the lower pivot arm assembly. The rear wheel support unit also includes a means for supporting an axle of a rear wheel of the motorcycle, such as at least one axle plate. Although as few as a single axle plate may be used, more typically two axle plates positioned generally parallel to one another are used. The axle plates have an aperture configured to receive the axle of the rear wheel.

The rear wheel support unit comprises an upper arm assembly extending from the at least one axle plate and to the upper pivot arm assembly. A lower arm assembly extends from the at least one axle plate and to the lower pivot arm assembly. When two axle plates are incorporated, the upper arm assembly comprises generally parallel first elongated arms extending from the axle plates to the upper pivot arm assembly. Generally parallel second elongated arms extend from the axle plates to the lower pivot arm assembly. The upper arm assembly may be either fixed or pivotally connected to the at least one axle plate. Similarly, the lower arm assembly may either be pivotally connected or fixedly connected to the at least one axle plate.

A compressible shock unit is interconnected between the rear wheel support unit, at one end thereof, and the motorcycle frame at the opposite end thereof. Alternatively, the shock unit may be connected to either the upper pivot arm assembly and frame, or upper arm assembly and frame.

At least one control arm, and typically two generally parallel control arms, are each connected to the upper pivot arm assembly at a first end thereof. A generally opposite second end of the control arms are connected to the lower pivot arm assembly. Means are provided for controlling movement of the control arm.

In one embodiment, the movement controlling means comprises a shock absorber unit disposed between the first and second ends of the one or more control arms. Preferably, the shock absorber unit is adjustable.

In another embodiment, the control arm includes a hinge intermediate the first and second ends thereof. The movement controlling means comprises an idler arm pivotally connected to the control arm at a first end thereof, and to the motorcycle frame at an opposite end thereof. In one embodiment, the second end of the idler arm is pivotally connected to a rocker arm of a bell crank assembly pivotally connected to the motorcycle frame. The bell crank assembly includes an arm extending from the rocker arm to a pivotal connection with either the motorcycle frame, the upper pivot arm assembly, or the lower pivot arm assembly. Alternatively, a first arm may extend from the rocker arm to the upper pivot assembly, and a second arm extends from the rocker arm to the lower pivot arm assembly. Either the control arm, idler arm, or bell crank arm may be adjustable in length. Moreover, any of these arms may have a shock absorber unit disposed between first and second ends thereof. The shock absorber units may be controlled remotely and activated by air or hydraulic fluid, or even by a spring, so as to control the movement of the rear suspension system, and particularly the control arms.

The above-described system has a generally triangular configuration. With the system of the present invention, lateral stability is created for the rear wheel of the two-wheeled vehicle. In addition the axle location for the wheel is controlled in a structured motion in relation to the drive system, sprocket or shaft. The length of the arm assemblies and the length of the pivot arm assemblies interconnected with the control arms achieve the ability to position the rear axle in a unlimited number of positions in relation to the frame. This also means that it has the ability for a maintained equal distance from the drive system, sprocket or shaft in relation to the rear axle location in motion thus allowing no slack to be created in the drive system.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side elevational view of a motorcycle incorporating a rear suspension system embodying the present invention;

FIG. 2 is a perspective view of the rear suspension system embodying the present invention;

FIG. 3 is a side elevational view of the rear suspension system of FIG. 2 in a relaxed state;

FIG. 4 is a side elevational view of the rear suspension system of FIG. 2 in a compressed state;

FIG. 5 is a side elevational view of the rear suspension system showing altered pivot point locations;

FIG. 6 is a side perspective view of the rear suspension system similar to that illustrated in FIG. 2 displaying a one-sided axle support plate.

FIG. 7 is a side elevational view of the rear suspension system, illustrating shock absorbers incorporated into an upper control arm, idler arm and bell crank control arm.

FIG. 8 is a side elevational view of the rear suspension system, illustrating an alternative embodiment of the present invention;

FIG. 9 is a side elevational view of an alternative embodiment of the rear suspension system, incorporating a shock system on the control arm system.

### DETAILED DESCRIPTION OF THE PREFERRED EMBODIMENTS

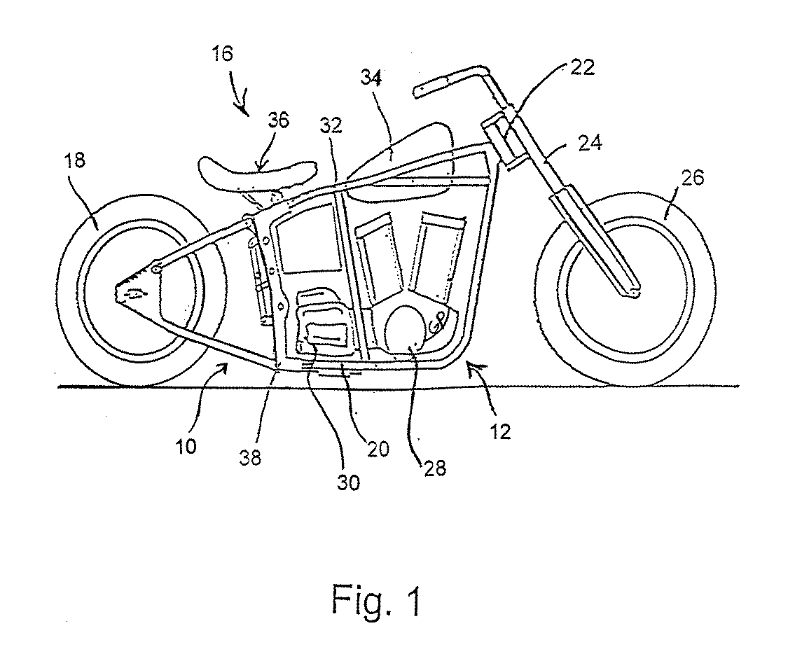

As shown in the drawings for purposes of illustration, the present invention is concerned with a rear suspension system for two-wheeled vehicles, generally referred to by the reference number 10 in FIGS. 1-9. The rear suspension system 10 is particularly designed and adapted for use in a motorcycle 16.

With reference to FIG. 1, a motorcycle 16 is illustrated incorporating the rear suspension system 10 of the present invention. The primary structural component of the motorcycle is the frame 12. The frame 12 is typically comprised of two bottom support tubes 20 which are bent at an upwardly directed angle at a front end thereof to a head tube 22. The head tube 22 is connected to a front wheel torque assembly 24 upon which the front wheel 26 is rotatably mounted. The bottom support tubes 20 also provide an anchor and base for the motor 28, transmission 30, etc. A top support tube 32 extends from the head tube 22 towards the rear of the motorcycle 16, and supports the gas tank 34, seat 36, etc. A rear pair of tubes 38 interconnect the top and bottom support tubes 32 and 20, and serve as a rear end of the overall frame 12. Conventionally, the rear suspension is connected to the rear pair of tubes 38 with cross bars or the like. In the present invention, a generally triangular triaxial suspension system 10 extends between the rear tubes 38 and the rear wheel 18 of the motorcycle 16.

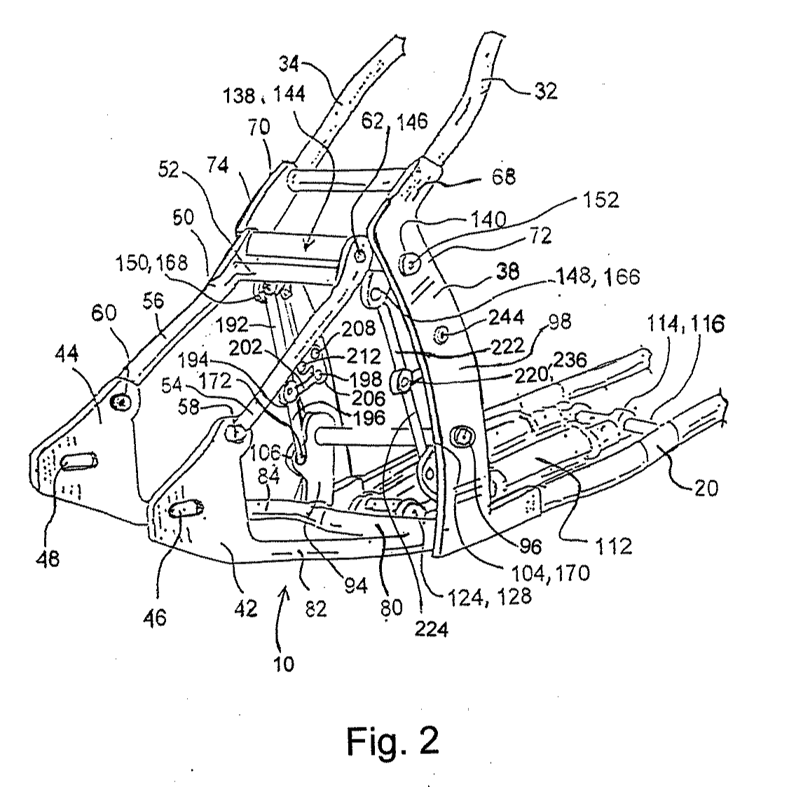

With reference to FIG. 2, the rear suspension system 10 of the present invention includes an upper pivot arm assembly 134 comprising a pair of angular brackets 136 and 138 spaced apart and generally parallel to one another. A first base 140 extends between the first ends thereof for the pivotal connection between the rear tubes 38 of the frame 12, typically by pins 152 and 154 extending between the mounting ears 72 and 74 extending from the upper frame unit 68 and 70 extending from the rear tubes 38 of the frame 12. Of course, other appropriate means of pivotally connecting the upper pivot arm assembly 134 to the rear portion of the frame 38 can also be used. A second base 144 extends between the second ends thereof for the pivotal connection between the upper arm assembly arms 62 and 64, typically by pins 146 and 158 extending between the upper pivot arm brackets 136 and 138 extending to the upper arms 54 and 56 of upper arm assembly 50. Of course, other appropriate means of pivotally connecting the upper pivot arm assembly 134 to the upper arm assembly 50 can also be used.

The upper arm assembly 50 is generally U-shaped, and includes a base 52 having first and second elongated arms 54 and 56 extending to connection points 58 and 60 of the axle plates 42 and 44, respectively, which may be pivotal. Typically, the arms 54 and 56 are rigidly connected to an upper portion of the upper arm assembly 52 which allows the arms 54 and 56 to pivot and rotate, such as by means of rocker arm fasteners, pins, bushings, etc. The upper arm assembly 50 is pivotally connected to the upper pivot arm assembly 134 typically by pins 156 and 158 extending between upper pivot arm brackets 136 and 138 extending between the first and second elongated arms 54 and 56 from the base shaft 52. Of course, other appropriate means of pivotally connecting the upper arm assembly 50 to the upper pivot arm assembly can also be used.

A lower arm assembly 78 extends adjacent to a lower portion of the rear end 38 of frame 12, and a lower end of each axle plate 42 and 44. The lower arm assembly 78 includes a generally U-shaped member having a base 80 and elongated arms 82 and 84 extending from the base 80 to a connection point on each respective axle plate 42 and 44, which may be pivotal.

The lower arm assembly 78 is pivotally connected to the frame 12 via a lower pivot arm assembly 90. This assembly 90 is generally H-shaped and includes two brackets, 92 and 94 which are angled and spaced apart from one another so as to be generally parallel to one another. A shaft or pin 96 extends between a first end of the brackets 92 and 94 for pivotal connection to mounting ears 98 and 100 extending from the rear frame tubes 38. Similarly, a shaft or pin 102 extends through the opposite ends of the brackets 92 and 94 for pivotal connection to lower arm assembly 82 and 84, usually intermediate ends thereof. Although the pivot arms 90 and 134 are illustrated as having an angled configuration, it should be understood that the invention is not limited to such, the pivot arms also being capable of being designed to be straight and without angle.

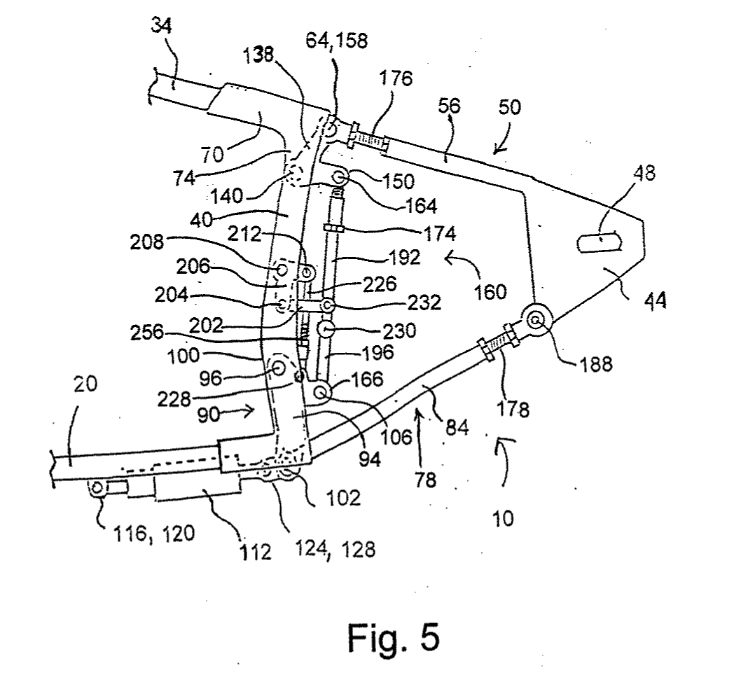

The lower arm assembly 78 may include pivotal connections 188 to axle plates 42 and 44, as shown in FIG. 5, thus allowing the upper arm assembly 50 to be solidly connected to the axle plates 42 and 44.

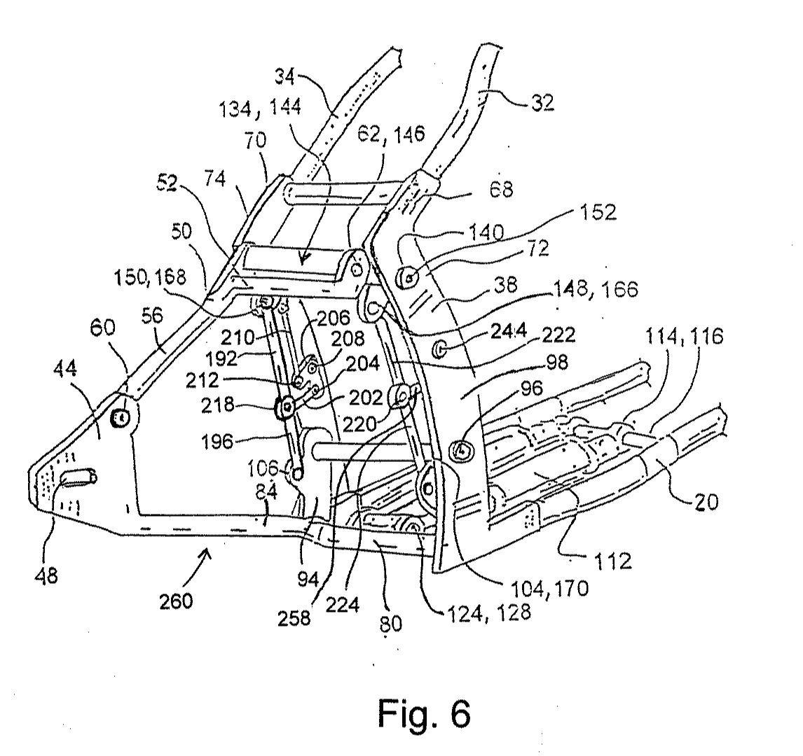

The upper and lower arm assemblies are collectively referred to herein as a rear wheel supporting unit, which serves to connect an axle of the rear wheel of the vehicle. Typically, there are two generally parallel and spaced apart, axle plates 42 and 44, which include aligned apertures 46 and 48 for receiving an axle of the rear wheel 18 of the motorcycle. However, it will be appreciated by those skilled in the art that there can be as few as a single axle plate 44, as illustrated in FIG. 6.

A shock unit 112, such as a shock absorber typically having a compressible spring, is pivotally interconnected between the rear wheel supporting unit and the frame 12 of the motorcycle 16. As shown in FIGS.1-9, the shock unit 12 is interconnected between the lower tubes 20 of the frame 12 and the lower arm assembly 78 or pivot arm assembly 90. Typically, this is done by connecting an upper end of the shock unit 112 with an appropriate fastener 118 and 120, such as a rotatable pin or the like, to mounting ears 114 and 116 extending from the lower tubes 20 of the frame 12, or any other rear end portion of the frame 12. The opposite end of the shock unit 112 is pivotally attached intermediate ends of the lower arm assembly brackets 122 and 124. This is done by attaching the appropriate fastener, such as pins 126 and 128 or the like. The one or more shock units unit shown in the horizontal position may be also placed in the vertically position upwardly within the vertical frame rails 38 and 40.

A control arm assembly 160 is pivotally interconnected between the upper pivot arm assembly 138 and the lower pivot assembly 90. The control arm assembly 160 is incorporated to control and, if necessary, adjust, the movement of the rear wheel suspension system. As will be more fully described herein, means are provided for controlling the movement of the control arms, such that the desired arcuate path is achieved when the rear suspension of the present invention moves between relaxed and compressed states, so as to retain to the greatest extent possible the rear wheel 18 of the motorcycle in engagement with the driving surface and provide lateral stability.

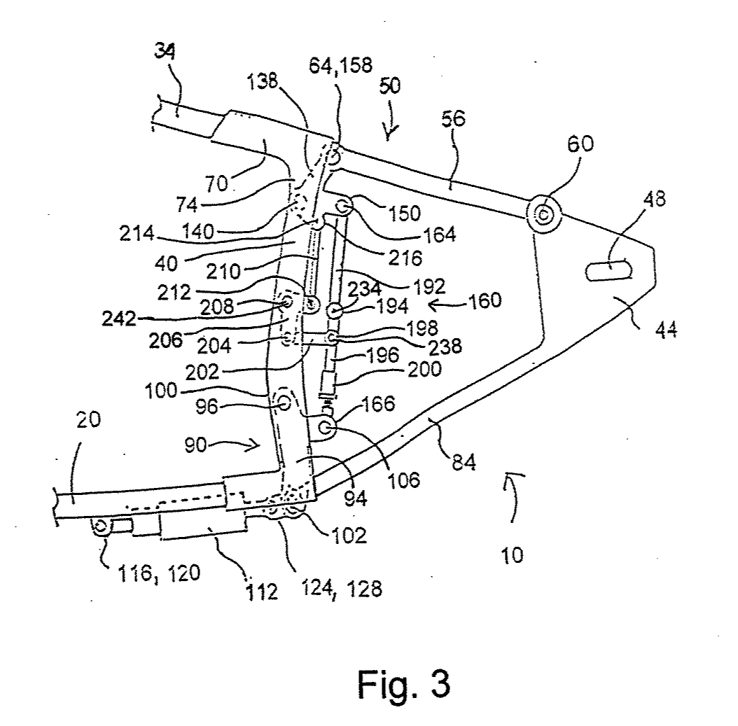

FIG. 3 illustrates the suspension system 10 of the present invention in a relaxed state. A control arm assembly 160 is pivotally interconnected to the upper pivot arm assembly 138 and the lower pivot arm assembly 90. The first ends of control arms 192 and 222 are pivotally connected to the upper pivot arm assembly 138 typically by pins 166 and 168 extending between mounting ears 148 and 150 extending from the upper pivot arm plates 138 and 140. The second ends of the control arms 192 and 222 are pivotally connected to an idler arm assembly 202 and 220, typically by pins 234 and 236. The control arms 190 are hinged or include pivot points intermediate the ends thereof in this particular embodiment. This can be considered to be two control arms pivotally connected to one another, or a single control arm having a pivot point intermediate the ends thereof.

Extending from the lower brackets 92 and 94 the lower control arms 196 and 224 are also interconnected to idler arm assemblies 202 and 220, shown in this position connected with the same pins 234 and 236. The second ends of the upper and lower control arms 192,196 and 222,224 are pivotally connected to the idler arms 202 and 246. The first ends of the idler arms 202 and 246 are pivotally connected to bell crank assemblies 206 and 248 the second ends are pivotally connected to the control arms 196, 224.

The bell crank assembly rocker arms 206 and 246 are pivotally connected to the frame rails 38 and 40 through pins 242 and 244. The bell crank assemblies 206 and 248 are also pivotally connected to the first ends of the bell crank control arms 210 and 250. The second ends of the bell crank control arms 210 and 250 are pivotally connected to the upper pivot arm assemblies 138 and 140 through pins 214 and 252 and brackets 216 and 254. Although two control arms 162 and 164 are shown, only one control arm may be used.

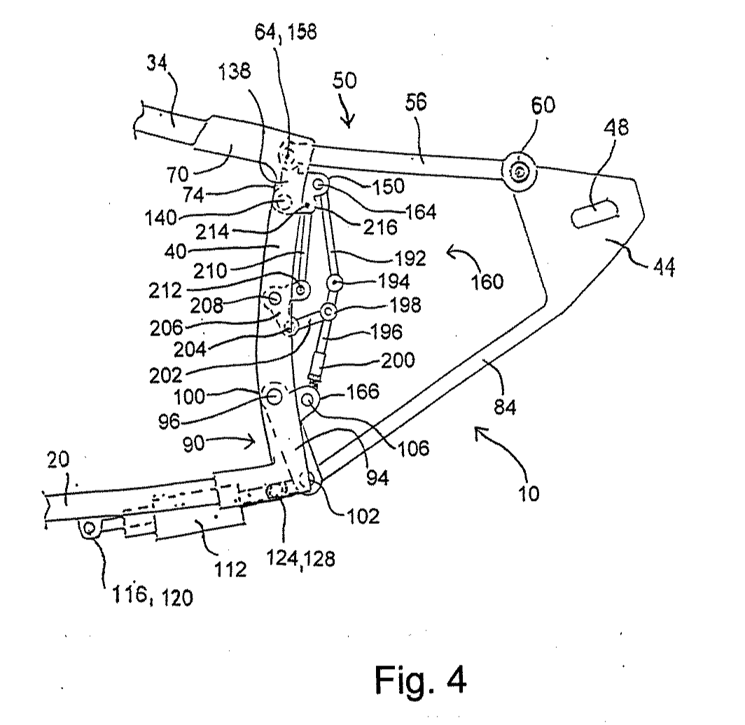

FIG. 4 illustrates the suspension system 10 in a compressed state, such as when the rear wheel 18 encounters a bump. As the motorcycle 16 moves and is subjected to uneven surface bumps or ruts, the system 10 acts in the following manner. The overall movement can best be described as a knee-action movement. As the shock unit 112 is compressed from upper pressure of the wheel 18, the pivot arm assemblies 94 and 138 are pivoted upwardly about the axis of fasteners. This results in the lower arm assembly 90 pivoting in an upward planar motion causing the control arm assembly 160 to release the upper pivot arm assembly 138 to pivot in a relative motion thus controlling the motion of the axle plates 42 and 44 to move upwardly in a planar motion as well. The upper arm assembly 50 also articulates and pivots upwardly in response. The pivotal connection 60 rotates between the upper arm assembly 56 and the axle plate 44 to continue the arc pattern as desired.

The upper pivot arm 138 motion upwardly pulls on the control arm 192. The upper pivot arm 138 is also pivotally connected to the bell crank control arm 210 which in turn pulls on bell crank assembly 206. The bell crank assembly 206 is pivotally connected to the frame rails 38 and 40 and is also pivotally connected the idler arm 202 which creates a push motion on the control arm assembly 160. This motion creates a hinge effect on the upper control arm 192 and the lower control arm 196 which are interconnected by the idler arm 202 pivotal connection 198. This results in a controlled preset motion for fine tuning the upwardly directed planar directional movement. The amount of travel of motion of the upward arm is controlled by the shock unit 112. As this pressure is reduced, the system 10 reverses this action and conforms to its balanced pre-shock tension position, as illustrated in FIG. 3. The system 10 maintains tension through the weight of the motorcycle 16 pressing down on the shock unit 112.

The downward rebound pivotal motion of the rear suspension system 10 is essentially the reverse of that described above. As the compressible shock unit 112 decompresses after rebound, the lower pivot arm assembly 94 pivots in a downward motion causing the control arm assembly 160 to pull on the upper pivot arm assembly 138. Thus, the lower arm assembly 84 to moves in a downward motion. As the upper pivot arm 138 returns downward, pushing down the bell crank control arm 210 and rotating the bell crank assembly 206, the idler arm 202 in turn pulls on the control arms 192 and 196 hinging them in a desired motion. This causes the axle support plate 44 to move downward, resulting in the upper arm assembly 56 being pulled downward also. The upwardly and downwardly directed motions are eventually ceased by virtue of the shock-absorbing unit 112.

With reference to FIG. 5 adjustable screw assemblies 174, 176, 178, 256 are shown that may be placed on the arm assemblies 192, 56, 84, 226 and on the opposite ends of the arm assemblies for tuning the suspension. These adjustable screw assemblies 174, 176, 178 may move the arm assemblies to a location that may help alignment and control travel that will benefit the suspension system stability.

The control arm assembly 160 may include an adjustable screw assembly 174 comprising a male screw unit attached to the control arm assembly 192 and a counterpart female screw receiver attached to the other end with a locking device such as a jam nut or the like. The upper arm assembly 56 includes an adjustable screw assembly 176 and the lower arm assembly 84 includes an adjustable screw assembly 178, as described above. Additionally, the bell crank control arm 226 may include an adjustable screw assembly 256 similar to the adjustable screw assembly 174 described above.

These adjustable screw assemblies 174, 176, 178, 256, as described above, may be placed on opposite ends of the arm assemblies. Of course, other means of making the control arms and assemblies adjustable which are known in the art are contemplated by the invention as well.

With continuing reference to FIG. 5, the rear suspension system 10 of the present invention is shown with the lower arm assembly 84 pivotally connected through pivot point 188 to the axle plate 44. The upper arm 56 is shown connected to the axle plate 44 without a pivotal connection. It will be appreciated by those skilled in the art that the pivotal connection points, if any, to the axle plates 42 and 44, may be changed as needed. Additionally, the bell crank control arm 226 is shown pivotally connected to the lower pivot arm 94. The opposite end of the bell crank control arm 212 is pivotally connected to the bell crank 206 pivotal connection 212. The lower control arm 196 is pivotally connected to the lower area of the idler arm assembly 202 at the pivotal connection 230. Altering this pivot point changes deflection speeds.

With reference to FIG.6, the rear suspension system 10 of the present invention is shown with a one-sided arm suspension system 260 using the upper arm 56 and the lower arm 84 interconnecting the single axle plate 44. The one-sided arm suspension system 260 supports the axle plate 44 and axle receiver 48 for the wheel 18.

With continuing reference to FIG. 6, the right side control arms 224 and 222 are pivotally connected to the idler arm 258 at pivotal connection 220. The left side control arms 192 and 196 are pivotally connected to the idler arm 202 at pivot connection 218. The different locations of these pivotal connections provide alternate types of deflections causing more or less motion altering the speed the control arms 222, 224, 192, 196, and in turn the motion of the interconnecting upper pivot arm assembly 134 and the lower pivot arm assembly 90.

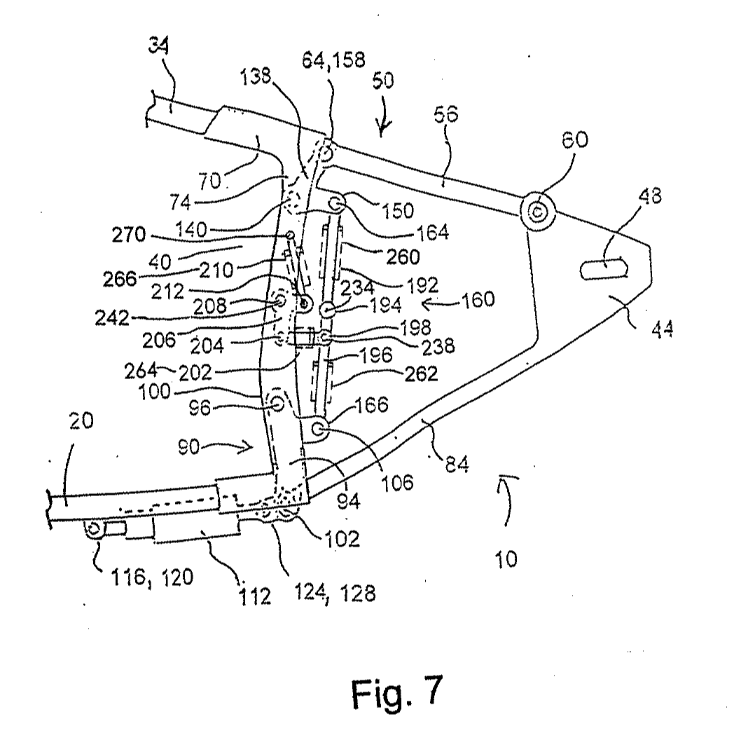

With reference now to FIG. 7, a shock spring unit assembly 260 may be incorporated as a part of the upper control arm assembly 192. Shock spring unit assembly 262 may be incorporated as a part of the lower control arm assembly 196 too. The shock spring unit assembly 266 may be incorporated as a part of the bell crank control arm assembly 210 and a shock spring unit assembly 262 may be incorporated as a part of the idler arm assembly 202. One or more of these spring shock assemblies 260, 262, 264 and 266 may be used to create motion in the system that is desirable. These spring shock unit assemblies may be remotely manually or computer operated with compressible air, oil or the like using tubes, hoses, wires or other suitable operating means.

Additionally, the bell crank control arm assembly 210 may be positioned and fixed by pin 270 on the rear frame section 40 or other part of frame sections to position the bell crank assembly 206 in a position that allows the idler arm assembly 202 to rotate and pivot in a manner that allows the control arm to hinge and deflect altering there motion during the motion upward and downward of the pivot arms 138 and 94. These alterations if used may enhance the functions of this suspension.

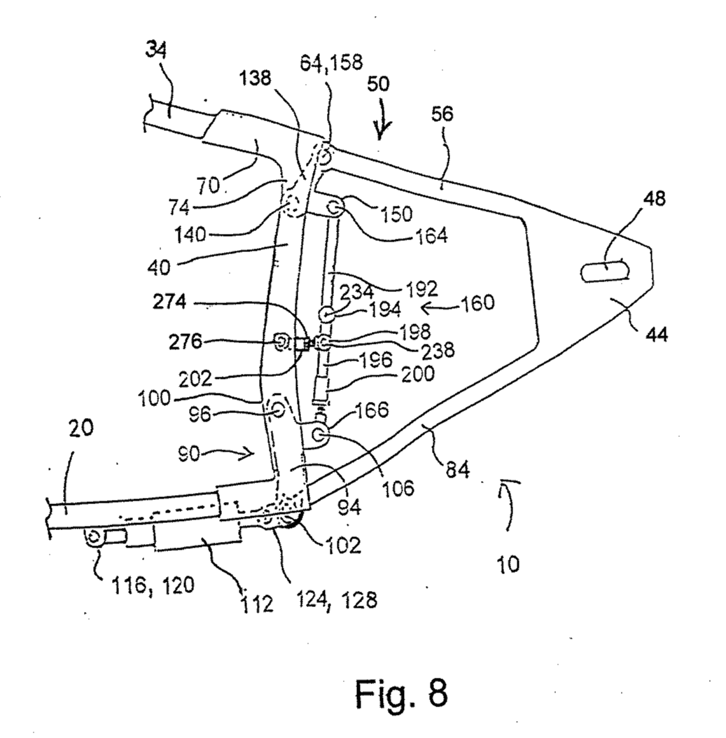

With reference to FIG. 8, the idler arm assembly 202 is shown with a pivotal connection 198 on one end to the lower control arm 196 and the opposite pivotal end 276 is connected to the frame rear section 40 or to other frame members. When the rear suspension 10 from shock 112 compresses the upper pivot arm assembly 138 rotates upward and pulls on the upper control arm assembly 192 in a manner that alters the length in the control arms 192 and 196 by hinging them at pivot point 194 as shown in FIG. 4. This hinging effect can counter any problems occurring in the arc rotation of the arms 56 and 84 connected to the axle plate 44. Following the rotation of the rear suspension 10 from the compression state, as stated above, the shock 112 decompresses and the lower pivot arm 94 moves downward pulling on the lower pivot control arm 196 that is pivotally interconnected with the idler arm 202. The upper control arm 192 thus pulls the upper pivot arm 138 in a downward motion from the pivotal connection 164. This motion allows the upper arm 56 to move down via the axle plate 44 connection point 48 allowing the wheel 18 to move downwardly with the suspension 10.

The idler arm 202 is shown with an adjustment screw assembly 274 that may be used to adjust the degree of motion. The upper arm 56 and lower arm 84 is shown with no pivotal connection to the axle plate 44. This may be accomplished if the arms 56 and 84 and axle plate 44 work in a manner with the control arm system 160 to move in a fashion not to bend from their original location. In FIG. 3, there is normally a pivotal connection on one of the arms connecting 56 and 84 to the rear axle plate 44.

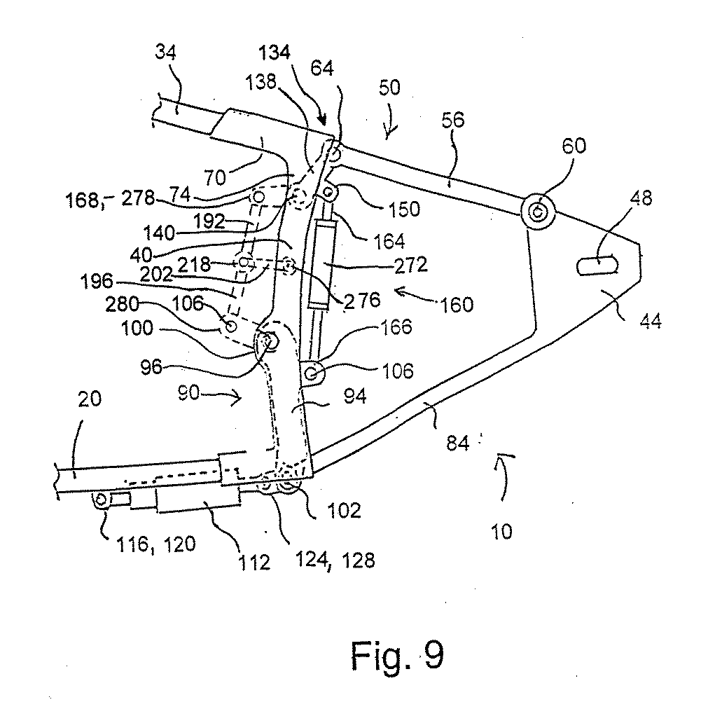

With reference to FIG. 9, the suspension system 10 is fitted with a shock spring assembly 272 providing compression in either a pushing motion or pulling motion as a part of the control arm 164. The spring shock assembly 272 is capable in providing rotational qualities in compensating arc patterns. The shock spring assembly 272 may be one unit or more and may be remotely operated with compressible air, oil or the like using tubes, hoses, wires or other suitable means and operated manually or by computer. This embodiment shows the bell crank assembly and the idler arm assembly not being used. The upper arm 56 with pivotal connection 60 to the axle plate 44 and the lower arm 84 work together with the lower pivot arm 94 interconnection through the pivotal connection mounting ear 100 of rear frame section 40. The mounting ear 166 pivotal connection 106 on the lower pivot arm 94 connects the control arm 164 through the shock spring system 272 to the mounting ear 150 of the upper pivot arm 138 allows the suspension 10 to rotate in manner specified in FIG. 4. with the exception that the control arm 164 does not hinge but slidably telescopes due to the incorporation of shock unit 272.

With continuing reference to FIG. 9, optional locations for control arm assemblies are shown in dashed lines. The upper pivot arm assembly 138 is shown with a relocated upper control bracket 278 with pivotal connection 168 to the upper control arm 192. The opposite end of the upper control arm 192 pivotally interconnects the lower control arm 196 and the idler arm 202 with pivotal connection 218. The idler arm 202 is pivotally connected to the frame section 40 through pivotal connection 276. The lower control arm 196 continues down and is pivotally connected to the lower pivot arm assembly 94 through the relocated bracket mounted 280 with pivotal connection 106. The upper pivotal bracket connections 278 of upper control arm assembly 192 may be placed anywhere as a part of the upper arm assembly 134 and the lower pivotal bracket connections 280 of the lower control arm assembly 196 are not limited to locations shown as they may be placed any where within the lower pivot arm assemblies 90.

Use of the present invention is advantageous over existing rear suspension systems in that improved rear wheel contact with the ground is achieved. Also, rear wheel control and stability is also greatly increased, resulting in additional safety. Improved arc from the rear axle sprocket location in relation to the transmission sprocket is achieved, allowing the ability to provide an exact arc that does not allow slack in the drive system (chain, belt etc.), thus allowing drive systems on suspension units that otherwise would not be possible.

Use of the present invention also allows the placement of the upright frame rear frame rails 38 and 40 may also be placed inboard on the rear frame platform between 34 and 20 to allow drive systems to be placed on the outside of these rails. The upper and lower arms that extend out to the axle support plate then can be routed around the drive system.

Although several embodiments have been described in detail for purposes of illustration, various modifications may be made to each without departing from the scope and spirit of the invention. Accordingly, the invention is not to be limited, except as by the appended claims.

What is claimed is:

1. A rear suspension system for a motorcycle, comprising:
an upper pivot arm assembly pivotally connected to a frame of the motorcycle;
a lower pivot arm assembly pivotally connected to the frame of the motorcycle;
a rear wheel support unit having an upper end thereof pivotally connected to the upper pivot arm assembly, and having a lower end thereof pivotally connected to the lower pivot arm assembly, and including means for supporting an axle of a rear wheel of the motorcycle;
a control arm having a first end connected to the upper pivot arm assembly, and a generally opposite second end thereof connected to the lower pivot arm assembly; means for controlling movement of the control arm; and
a compressible shock unit interconnected between the rear wheel support unit at one end thereof, and the motorcycle frame at the opposite end thereof.

2. The system of claim 1, wherein the axle support means comprises at least one support axle plate having an aperture configured to receive the axle of the rear wheel.

3. The system of claim 2, wherein the rear wheel support unit comprises an upper arm assembly extending from the at least one axle plate and to the upper pivot arm assembly, and a lower arm assembly extending from the at least one axle plate and to the lower pivot arm assembly.

4. The system of claim 3, wherein the at least one support axle plate comprises two generally parallel axle plates, and wherein the upper arm assembly comprises generally parallel first elongated arms extending from the axle plates to the upper pivot arm assembly, and generally parallel second elongated arms extending from the axle plates to the lower pivot arm assembly.

5. The system of claim 3, wherein the upper arm assembly is pivotally connected to the at least one axle plate.

6. The system of claim 3, wherein the lower arm assembly is pivotally connected to the at least one axle plate.

7. The system of claim 1, wherein the control arm comprises two generally parallel control arms, each connected to the upper pivot arm assembly at a first end thereof, and to the lower pivot arm assembly at a second end thereof.

8. The system of claim 1 wherein the movement controlling means comprises a shock absorber unit disposed between the first and second ends of the control arm.

9. The system of claim 8, wherein the shock absorber unit is adjustable.

10. The system of claim 1, wherein the control arm includes a hinge intermediate the first and second ends thereof.

11. The system of claim 10 wherein the movement controlling means comprises an idler arm pivotally connected to the control arm at a first end thereof and to the motorcycle frame at an opposite second end thereof.

12. The system of claim 11 wherein the second end of the idler arm is pivotally connected to a rocker arm of a bell crank assembly pivotally connected to the motorcycle frame.

13. The system of claim 12, wherein the bell crank assembly includes an arm extending from the rocker arm to a pivotal connection with either the motorcycle frame, the upper pivot arm assembly or the lower pivot arm assembly.

14. The system of claim 1, wherein the control arm is adjustable in length.

15. The system of claim 11, wherein the idler arm is adjustable in length.

16. The system of claim 13, wherein the bell crank arm is adjustable in length.

17. The system of claim 11, including a shock absorber unit disposed between first and second ends of the idler arm.

18. The system of claim 13, including a shock absorber unit disposed between first and second ends of the bell crank arm.

19. The system of claim 12, including a first arm extending from the rocker arm to the upper pivot arm assembly, and a second arm extending from the rocker arm to the lower pivot arm assembly.

20. The system of claim 19, wherein the first arm is pivotally connected to the rocker arm and the upper pivot arm assembly, and the second arm is pivotally connected to the rocker arm and the lower pivot arm assembly.
